(19) United States
(12) Patent Application Publication
(10) Pub. No.: US 2022/0019932 A1
(43) Pub. Date: Jan. 20, 2022

(54) AUTOMATIC GENERATION OF ODATA SERVICES FROM SKETCHES USING DEEP LEARNING

(71) Applicant: SAP SE, Walldorf (DE)

(72) Inventors: Qiu Shi Wang, Singapore (SG); Lin Cao, Singapore (SG)

(21) Appl. No.: 16/928,098

(22) Filed: Jul. 14, 2020

(51) Int. Cl. G06N 20/00; G06N 3/08

(52) U.S. Cl. CPC G06N 20/00; G06N 3/08

(57) ABSTRACT

Methods, systems, and computer-readable storage media for receiving, by an Open Data Protocol (OData) service generation platform, an image of a sketch on a physical artifact, processing the image using a set of ML models to detect depiction of two or more entities and at least one association between entities, the set of ML models including at least one layout analysis ML model to identify two or more sections within images, at least one object detection ML model to identify one or more of entities and associations in each section of the two or more sections, and at least one text recognition ML model to determine text associated with entities in sections, generating an entity data model (EDM) based on output of the ML models that includes the two or more entities and the at least one association, and providing an OData service based on the EDM.

### BACKGROUND

The Open Data Protocol (OData) is a protocol that defines a set of best practices for creating, querying, and updating data using simple hypertext transfer protocol (HTTP) messages. OData is a flexible technology that enables interoperability between disparate data sources, applications, services, and clients. OData is widely used as a backbone to support software services and applications, especially data-centric cloud services and web and mobile applications.

The workflow of software development related to OData services typically starts from a design thinking workshop where, after discussion between customers and analysts, a sketch of a data model is provided. For example, during a workshop, a sketch of the data model can be drawn on a whiteboard, paper, napkin, or the like. That is, the data model can be represented in a sketch that is a real-world, physical artifact. After the workshop, the sketch is used by a development team to begin development of an OData service based on the sketch. Using the sketch, software developers define the entity data model (EDM) of the OData service. The EDM can be provided in an appropriate format, which can include extensible markup language (XML) and JavaScript object notation (JSON). The OData service is then programmed in an appropriate programming language, which can include Java. The resulting OData service can be populated with demo data to enable demonstration of execution of the OData service.

Development of OData services is a time- and resource-intensive task. It may take days or even weeks to develop a prototype OData service for analysts to have a live demo for customers to collect further feedback. With this comes the expenditure of technical resources in the prolonged development process (e.g., computing resources and coding software used by developers). Further, iterations typically occur multiple times before the prototype service meets requirements. Such iterations imply further expenditure of technical resources. Also, a pain point of customers is that they need to wait for a long time (days or weeks) to be able see an initial visual demo. In parallel, a pain point of the development team is that they must spend significant amounts of effort to first develop the OData services without knowing whether it meets the requirements of customers. In some instances, development effort is wasted, because developers do not understand the customer requirements clearly at the outset. A pain point of analysts is that they do not have anything visible and runnable to show to customers in the first instance, making it difficult to clarify accurate requirements from the customers.

### SUMMARY

Implementations of the present disclosure are directed to generating Open Data Protocol (OData) services. More particularly, implementations of the present disclosure are directed to a service provisioning platform for automatically generating OData services from images using machine learning (ML).

In some implementations, actions include receiving, by an OData service generation platform executed in one or more cloud-computing environments, an image including data representative of a sketch on a physical artifact, the image being provided as a computer-readable image file, processing, by the OData service generation platform, the image using a set of ML models to detect depiction of two or more entities and at least one association between entities, the set of ML models including at least one layout analysis ML model to identify two or more sections within images, at least one object detection ML model to identify one or more of entities and associations in each section of the two or more sections, and at least one text recognition ML model to determine text associated with entities in sections, generating, by the OData service generation platform, an entity data model (EDM) based on output of the set of ML models, the output including the two or more entities and the at least one association, and providing, by the OData service generation platform, an OData service based on the EDM. Other implementations of this aspect include corresponding systems, apparatus, and computer programs, configured to perform the actions of the methods, encoded on computer storage devices.

These and other implementations can each optionally include one or more of the following features: processing, by the OData service generation platform, the image is performed in response to determining that the image depicts the sketch using at least one ML model; generating the EDM at least partially includes populating a template EDM based on the output; the EDM is provided in Common Schema Definition Language (CSDL); the image is pre-processed to adjust one or more parameters prior to execution of processing, by the OData service generation platform, the image; the image is pre-processed by a remote device before being transmitted to the OData service generation platform; and one or more ML models include a convolutional neural network (CNN).

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

The patent or application file contains at least one drawing executed in color. Copies of this patent or patent application publication with color drawing(s) will be provided by the Office upon request and payment of the necessary fee.

FIG. 1 depicts an example architecture that can be used to execute implementations of the present disclosure.

FIG. 2 depicts an example conceptual architecture in accordance with implementations of the present disclosure.

FIG. 3A depicts an image of an example sketch.

FIG. 3B depicts example layout labels determined for the example sketch of FIG. 3A resulting from layout processing.

FIG. 3C depicts example object labels determined for the example sketch of FIG. 3A resulting from object detection processing.

FIG. 4 depicts an example diagram of an OData service generated from the example sketch of FIG. 3A.

FIG. 5 depicts an example process that can be executed in accordance with implementations of the present disclosure.

FIG. 6 is a schematic illustration of example computer systems that can be used to execute implementations of the present disclosure.

Like reference symbols in the various drawings indicate like elements.

### DETAILED DESCRIPTION

Implementations of the present disclosure are directed to generating Open Data Protocol (OData) services. More particularly, implementations of the present disclosure are directed to a service provisioning platform that automatically generates OData services from images using machine learning (ML). Implementations can include actions of receiving, by an OData service generation platform executed in one or more cloud-computing environments, an image including data representative of a sketch on a physical artifact, the image being provided as a computer-readable image file, processing, by the OData service generation platform, the image using a set of ML models to detect depiction of two or more entities and at least one association between entities, the set of ML models including at least one layout analysis ML model to identify two or more sections within images, at least one object detection ML model to identify one or more of entities and associations in each section of the two or more sections, and at least one text recognition ML model to determine text associated with entities in sections, generating, by the OData service generation platform, an entity data model (EDM) based on output of the set of ML models, the output including the two or more entities and the at least one association, and providing, by the OData service generation platform, an OData service based on the EDM.

To provide further context for implementations of the present disclosure, and as introduced above, OData is a protocol that defines a set of best practices for creating, querying, and updating data using hypertext transfer protocol (HTTP) messages. OData is a flexible technology that enables interoperability between disparate data sources, applications, services, and clients. OData is widely used as a backbone to support software services and applications, especially data-centric cloud services and web and mobile applications.

The workflow of software development related to OData services typically starts from a design thinking workshop where, after discussion between customers and analysts, a sketch of a data model is provided. For example, during a workshop, a sketch of the data model can be drawn on a whiteboard, paper, napkin, or the like. That is, the data model can be represented in a sketch that is a real-world, physical artifact. After the workshop, the sketch is used by a development team to begin development of an OData service based on the sketch. Using the sketch, software developers define the EDM of the OData service. The EDM can be provided in an appropriate format, which can include, without limitation, extensible markup language (XML) and Javascript object notation (JSON). The OData service is then programmed in an appropriate programming language, which can include, without limitation, Java. The resulting OData service can be populated with demo data to enable demonstration of execution of the OData service.

Development of OData services is a time- and resource-intensive task. It may take days or even weeks to develop a prototype OData service setup for analysts to have a live demo for customers to collect further feedback. With this comes the expenditure of technical resources in the prolonged development process (e.g., computing resources and coding software used by developers). Further, iterations typically occur multiple times before the prototype service meets requirements. Such iterations imply further expenditure of technical resources. Also, a pain point of customers is that they need to wait for a long time (days or weeks) to be able see an initial visual demo. In parallel, a pain point of the development team is that they must spend significant amounts of effort to first develop the OData services without knowing whether it meets the requirements of customers. In some instances, development effort is wasted, because developers do not understand the customer requirements clearly at the outset. A pain point of analysts is that they do not have anything visible and runnable to show to customers in the first instance, making it difficult to clarify accurate requirements from the customers.

In view of the above context, implementations of the present disclosure provide a ML-based platform for automatically generating OData services from images. The ML-based platform of the present disclosure, also referred to herein as a service provisioning platform, can be described as a no-code technology to automatically generate OData services from sketches (physical, real-world artifacts) powered by ML. The service provisioning platform provides automatic, rapid conversion of a sketch of a data model into an executable OData service that is visible and runnable on-the-fly (e.g., during a discussion with customers).

As described in further detail herein, a core of the service provisioning platform of the present disclosure includes an OData EDM generator, which leverages a set of ML services, each ML service providing one or more ML models (e.g., Convolutional Neutral Networks (CNNs)), to generate EDMs in Common Schema Definition Language (CSDL) from hand drawn sketches of OData model diagrams. The ML models are pretrained and deployed in cloud-computing environment(s), with capabilities such as image classification, layout identification, object detection and handwriting recognition. These ML models can be further customized with customer training data set to cater for different use cases and use scenarios.

In some implementations, the service provisioning platform of the present disclosure executes a process as follows. Initially, a sketch of a data model, which is hand drawn on a physical, real-world artifact (e.g., a whiteboard during a design thinking workshop) is recorded in an image (digital image) by a device (e.g., mobile device) and the image is submitted to the OData EDM generator, which is executed in a cloud-computing environment. The image is processed by the ML models, which provide output that is used to generate the OData EDM (e.g., in CSDL stored in XML or JSON file format). The EDM is sent to an OData service generator to generate OData services and populate demo data in real-time. As used herein, real-time may describe an operation that is performed without any intentional delay, taking into account the processing, and/or communication limitations of the computing system(s) performing the operation and the time needed to initiate, and/or perform the operation. Real-time may be used to describe operations that are automatically executed in response to a triggering event, for example, without requiring human input.

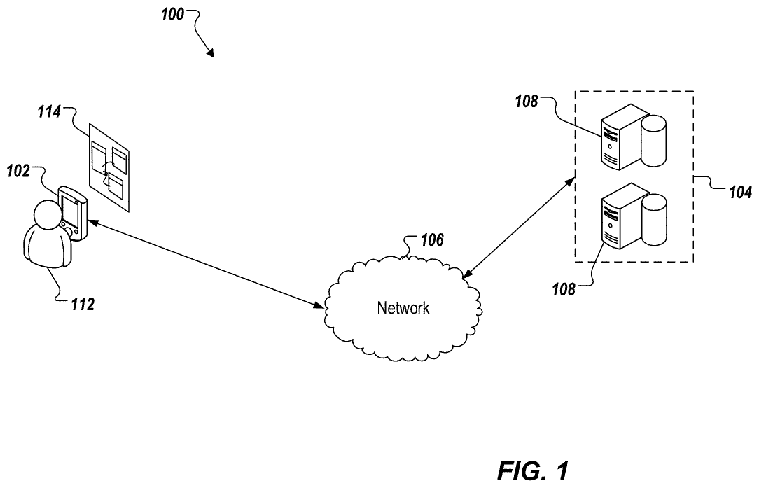

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In some implementations, the server system 104 can host a service provisioning platform for automatically generating OData services from images in accordance with implementations of the present disclosure. For example, a sketch 114 can be provided as a real-world, physical artifact (e.g., on a whiteboard, paper, napkin) and can depict a data model. The user 112 can capture an image of the sketch 114 and the image can be transmitted to the service provisioning platform to automatically generate a service, as described herein. In some examples, after the service is generated, the user 112 can interact with the service using the client device 102 to demo and/or test the service.

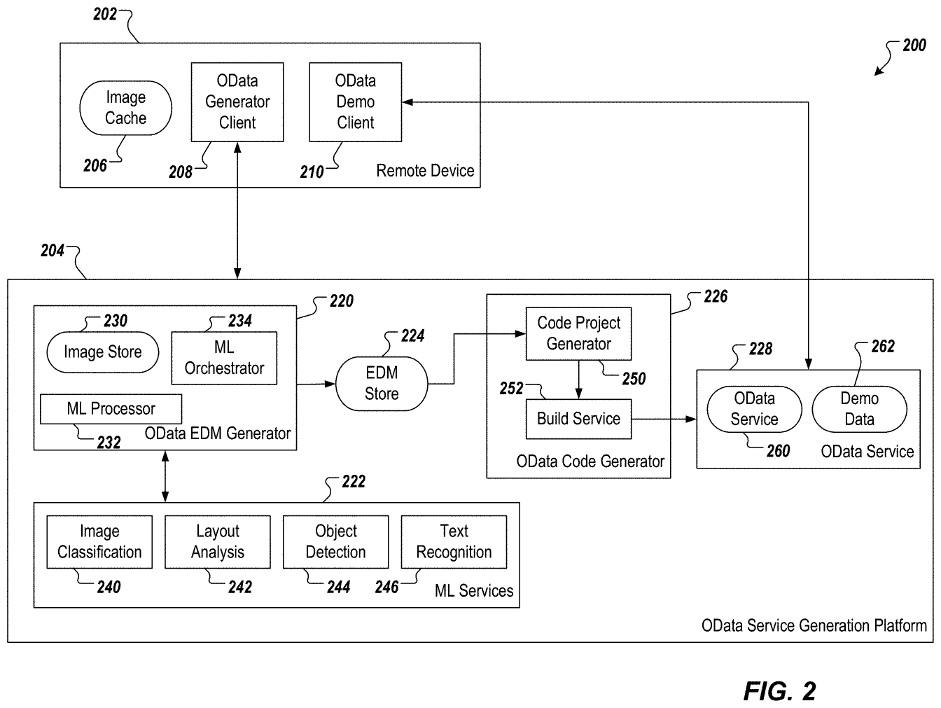

FIG. 2 depicts an example conceptual architecture 200 in accordance with implementations of the present disclosure. In the depicted example, the conceptual architecture 200 includes a remote device 202 and an OData service generation platform 204. For example, and without limitation, the remote device 202 can be the client device 102 of FIG. 1 and the OData service generation platform 204 can be hosted on the server system 104. In some examples, the remote device 202 and the OData service generation platform 204 communicate over a network (e.g., the network 106 of FIG. 1).

In the example of FIG. 2, the remote device 202 includes an image cache 206, an OData generator client 208, and an OData demo client 210. In some examples, the image cache 206 is provided as computer-readable memory for storing images that are to be processed by the OData service generation platform 204, as described herein. In some examples, the OData generator client 208 and the OData demo client 210 are each provided as one or more computer-executable programs executed by the remote device 202 to perform functionality, as described herein. For example, and as described in further detail herein, the remote device 202 can capture an image of a sketch (e.g., the sketch 114 of FIG. 1), which image is stored, at least temporarily, in the image cache 206. The OData generator client 208 can transmit a request to the OData service generation platform 204 for generation of an OData service based on the image. In some examples, the request includes the image and data representative of a context of the OData service that is to be generated.

In some examples, the image cache 206, the OData generator client 208, and the OData demo client 210 can be collectively provided as a cross-platform mobile application running on an operating system of the remote device 202. In some examples, the cross-platform mobile application can execute on any appropriate operating system.

In some implementations, the OData service generation platform 204 is hosted in one or more cloud-computing environments. In the example of FIG. 2, the OData service generation platform 204 includes an OData EDM generator 220, ML services 222, an EDM store 224, and an OData code generator 226. As described in further detail herein, the OData service generation platform 204 generates an OData service 228 based on an image provided from the remote device 202.

In the example of FIG. 2, the OData EDM generator 220 includes an image store 230, a ML processor 232, and an ML orchestrator 234. In the example of FIG. 2, the ML services 222 include an image classification service 240, a layout analysis service 242, an object detection service 244, and a text recognition service 246. In some examples, one or more of the ML services 222 is provided by a third-party service provider. In the example of FIG. 2, the OData code generator 226 includes a code project generator 250 and a build service 252. In the example of FIG. 2, the OData service 228 includes an OData service 260 and demo data 262.

In general, the OData service generation platform 204 can be provided as services running on a cloud platform. In accordance with implementations of the present disclosure, the OData EDM generator 220 generates an OData service EDM described in CSDL (e.g., in XML or JSON file format). In some examples, the image store 230 receive the image of a sketch uploaded from the remote device 202. In some examples, the ML Orchestrator 234 orchestrates interactions with the ML services (e.g., from respective cloud platforms), which provide image classification, layout analysis, object detection, and text recognition. In some examples, orchestration includes providing input to one or more of the ML services 222 through respective requests and receiving output from the one or more ML services 222 in response to the respective requests.

In some implementations, the OData EDM generator 220 processes the image and output received from the ML services 222 through one or more ML models of the ML processor 232. In some examples, the one or more ML models can include a series of deep learning (DL) networks, such as CNNs. In some examples, the ML models process the image to generate the OData EDM in XML or JSON file format as output. The generated EDM is written into the EDM store 224 and is pipelined into the OData code generator 226 to generate code (e.g., as a Java project) and build the OData service 228. For example, the OData service 228 represents an OData service that is automatically generated by the service provisioning platform of the present disclosure based on an image depicting a sketch of a data model.

Implementations of the present disclosure are described in further detail herein with reference to an example sketch. It is contemplated, however, that implementations of the present disclosure can be realized using any appropriate sketch (e.g., a sketch depicting a data model, upon which a service is to be based).

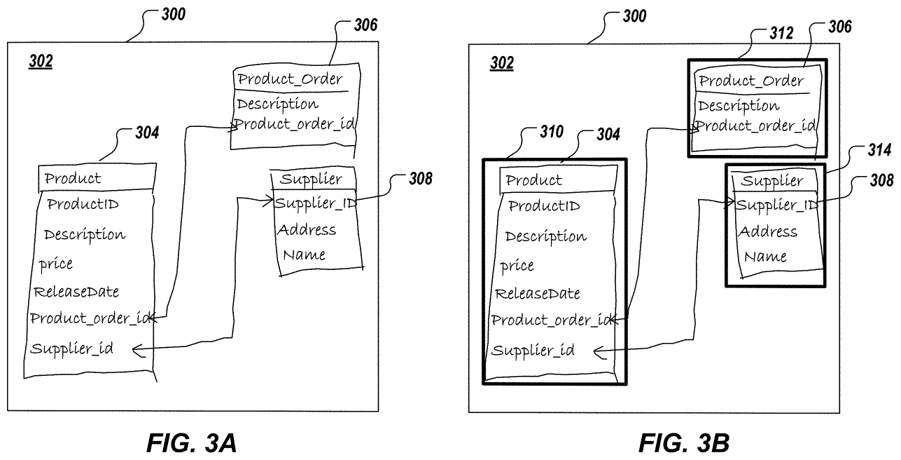

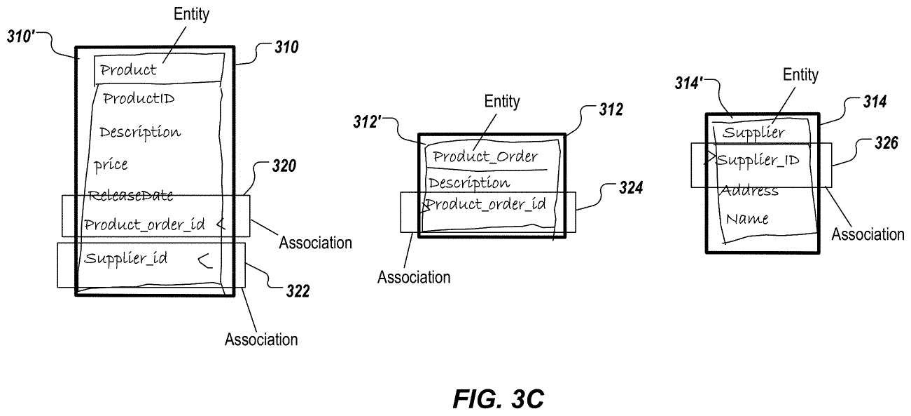

FIG. 3A depicts an image 300 of an example sketch 302. The example sketch 300 represents a data model including entities and associations between entities. In the example of FIG. 3A, an entity 304, an entity 306, and an entity 308 are depicted. Each entity is associated with an entity type name and a set of property names. In the example of FIG. 3A, the entity 304 includes [Product] as the entity type name and a set of property names that includes [ProductID, Description, Price, ReleaseDate, Product OrderID, SupplierID], the entity 306 includes [Product Order] as the entity type name and a set of property names that includes [Description, Product OrderID], and the entity 308 includes [Supplier] as the entity type name and a set of property names that includes [SupplierID, Address, Name]. In some examples, arrows indicate associations between entities. In the example of FIG. 3A, the property name [ProductID] of the entity 304 is associated with the property name [ProductID] of the entity 306, and the property name [SupplierID] is associated with the property name [SupplierID] of the entity 308.

In some implementations, the image 300 is captured by the remote device 202 and is pre-processed. In some examples, the OData generator client 208 pre-processes the image 300 to adjust one or more parameters. Example parameters can include, without limitation, contrast and brightness. For example, a parameter of the image 300 can be adjusted to a pre-defined value (e.g., if a parameter of the image 300 is above/below the pre-defined value, the parameter is adjusted down/up, respectively, to the pre-defined value). The image 300 (e.g., as pre-processed) is received by the OData service generation platform 204 from the remote device 202.

In some implementations, the image 300 is processed by the ML services 222 as orchestrated by the ML orchestrator 234 to generate an OData EDM (e.g., in XML or JSON file format). In some examples, the image 300 is processed by the image classification service 240, which processes the image 300 through a ML model (e.g., a CNN) to selectively classify the image 300 as depicting a hand-drawn sketch. For example, the image 300 is provided as input to the ML model, which provides an output indicating a classification (e.g., hand-drawn, not hand-drawn) of the image 300. If the classification does not indicate that the image 300 depicts a hand-drawn sketch, the image 300 is determined to be irrelevant and further processing of the image 300 ends. For example, the ML orchestrator 234 discontinues orchestration with the ML services 222.

If the classification indicates that the image 300 depicts a hand-drawn sketch, the ML orchestrator 234 provides the image 300 for processing by the layout analysis service 242. In some examples, the layout analysis service 242 processes the image 300 through a ML model (e.g., a CNN) to analyze the layout of the image 300 and divide the image 300 into multiple sections. In some examples, each section is associated with a respective layout label that can be represented as a boundary.

FIG. 3B depicts example layout labels 310, 312, 314 determined for the example image 300 of FIG. 3A resulting from layout processing. In this example, the layout labels 310, 312, 314 are provided as output of the ML model of the layout analysis service 242 identifying the presence of the entities 304, 306, 308, respectively, as sections within the image 300. The layout labels 310, 312, 314 are provided to the ML orchestrator 234 (e.g., as a layout label data set).

In some implementations, the ML orchestrator 234 provides the image 300 for processing by the object detection service 244 to identify entities and associations in each section determined from the layout analysis service 242. In some examples, the object detection service 244 processes the image 300 through a ML model (e.g., a CNN) to identify entities and associations in each section and provide respective labels.

FIG. 3C depicts example object labels 310′, 312′, 314′, 320, 322, 324, 326 determined for the example image 300 of FIG. 3A resulting from object detection processing. In this example, the labels 310′, 312′, 314′ identify the respective sections 310, 312, 314 as entities, and the labels 320, 322, 324, 326 identify respective associations between the entities. The labels 310′, 312′, 314′, 320, 322, 324, 326 are provided to the ML orchestrator 234 (e.g., as a label data set).

In some implementations, the ML orchestrator 234 provides the image 300 for processing by the text recognition service 246 to recognize the handwritten text of properties and conclude the associations of properties between entities depicted in the image 300. In some examples, the text recognition service 246 processes the image 300 through a ML model (e.g., a CNN) to provide the text of entities, properties, and associations. The text is provided to the ML orchestrator 234 (e.g., as a text data set).

In accordance with implementations of the present disclosure, the OData EDM generator 220 processes the output of the ML services 220 based on the image 300 to generate an OData EDM representative of the data model depicted within the image 300. In some examples, the OData EDM generator 220 populates a template EDM using the output of the ML services 222. Continuing with the example of FIGS. 3A-3C, the output of the ML services 222 can collectively indicate the following entities and respective properties and associations:

TABLE 1
Entities and Properties

| Entity | Properties |
|---|---|
| Product | ProductID, Description, Price, |
| | ReleaseDate, Product_OrderID, |
| | SupplierID |
| Product_Order | Description, Product_OrderID |
| Supplier | SupplierID, Address, Name |

TABLE 2
Associations

| Associated Entities | Associated Property |
|---|---|
| Product → Product_Order | Product_OrderID |
| Product → Supplier | SupplierID |

In some implementations, the OData EDM generator 220 iteratively populates the template EDM to provide the OData EDM. For example, at each iteration, the OData EDM generator 220 iteratively populates the template EDM with properties of a respective entity as property names and determines a data type for each property to populate the EDM template with respective data types. In some examples, data types are determined based on text of a respective property. Example data types can include, without limitation, string (e.g., String(128)), decimal (e.g., Decimal(16, 3)), integer (e.g., Int64), and date.

In some examples, recognized text of the properties of entities is compared between entities to validate the associations identified between the entities. For example, the recognized text [Product OrderID] in the [Product] entity is compared with the recognized text in the [ProductOrder] entity and it can be determined that it matches with [Product OrderID] in the [ProductOrder] entity. Consequently, it is confirmed that there is an association between [Product] and [ProductOrder] entities.

In some examples, the data types of each property of entities are omitted in the sketch and, thus, are not directly determined from the image 300. Accordingly, data types of properties can be automatically determined in generating the EDM. In some examples, the data type of a property is determined using, for example, text recognition, based on a property name determined for the property. For example, a property name can be compared to one or more regular expressions, each regular expression corresponding to a specific data type. If the property name, or a portion of the property name, corresponds to a regular expression, the data type of the regular expression is assigned to the property. For example, if the property name is [ProductID], which includes “ID” that can be detected in comparison with a regular expression, the property is assigned with T ype=“Edm. Int64” Nullable=“false” as a default value. As another example, if the property name is “Address” that matches a regular expression including “Address,” the property is assigned with Type=“Edm.GeographyMultiLineString” The entity properties determination can be customizable to support different customers and different use cases.

Continuing with the examples of FIGS. 3A-3C, an example EDM can be provided as:

Listing 1: Example EDM using CSDL in XML Format

<?xml version=“1.0” encoding=“utf-8”?>
<edmx:Edmx Version=“4.0” xmlns:edmx=“http://docs.oasis-
open.org/odata/ns/edmx”
xmlns:xsi=“http://www.w3.org/2001/XMLSchema-instance”
xsi:schemaLocation=“http://docs.oasis-open.org/odata/ns/edmx
http://docs.oasis-open.org/odata/odata/v4.0/os/schemas/edmx.xsd
http://docs.oasis-open.org/odata/ns/edm http://docs.oasis-
open.org/odata/odata/v4.0/os/schemas/edm.xsd”>
<edmx:Reference
Uri=“vocabularies/com.sap.cloud.server.odata.sql.v1.xml”>

<edmx:Include

```
Namespace=“com.sap.cloud.server.odata.sql.v1” Alias=“SQL”/>
  </edmx:Reference>
  <edmx:DataServices>
```

<Schema Namespace=“com.sap.odatademo”

Alias=“com_sap_odatademo” xmlns=“http://docs.oasis-
open.org/odata/ns/edm”>

<EntityType Name=“Product”>

<Key>
<PropertyRef Name=“ProductID”/>
</Key>
<Property Name=“Description” Type=“Edm.String”

Nullable=“false” MaxLength=“128”/>

<Property Name=“Price” Type=“Edm.Decimal”

Nullable=“false” Precision=“16” Scale=“3”/>

<Property Name=“ProductID” Type=“Edm.Int64”

Nullable=“false”/>

<Property Name=“ReleaseDate” Type=“Edm.Date”

Nullable=“false”/>

<NavigationProperty Name=“Product_Order”

Type=“com_sap_odatademo.Product_Order” Nullable=“false”
Partner=“Product”/>

<NavigationProperty Name=“Supplier”

Type=“com sap odatademo.Supplier” Nullable=“false”
Partner=“Product”/>

```
  </EntityType>
  <EntityType Name=“Product_Order”>
```

<Key>
<PropertyRef Name=“Product_OrderID”/>
</Key>
<Property Name=“Description” Type=“Edm.String”

Nullable=“false” MaxLength=“128”/>

<Property Name=“Product_OrderID” Type=“Edm.Int64”

Nullable=“false”/>

<NavigationProperty Name=“Product”

Type=“com_sap_odatademo.Product” Nullable=“false”
Partner=“Product_Order”/>

```
  </EntityType>
  <EntityType Name=“Supplier”>
```

<Key>
<PropertyRef Name=“SupplierID”/>
</Key>
<Property Name=“Address”

Type=“Edm.GeographyMultiLineString” Nullable=“false” SRID=“0”/>

<Property Name=“Name” Type=“Edm.String”

Nullable=“false” MaxLength=“64”/>

<Property Name=“SupplierID” Type=“Edm.Int64”

Nullable=“false”/>

<NavigationProperty Name=“Product”

Type=“com_sap_odatademo.Product” Nullable=“false”
Partner=“Supplier”/>

```
  </EntityType>
  <Function Name=“ProductsBySupplier”>
```

<Parameter Name=“Supplier”

Type=“com_sap_odatademo.Supplier” Nullable=“false”/>

<ReturnType

Type=“Collection(com_sap_odatademo.Product)”/>

```
  </Function>
  <EntityContainer Name=“OdatademoService”>
```

<Annotation Term=“SQL.TrackChanges”/>
<EntitySet Name=“ProductSet”

EntityType=“com_sap_odatademo.Product”>

<NavigationPropertyBinding Path=“Product”

Target=“ProductSet”/>

<NavigationPropertyBinding

Path=“Product_Order” Target=“Product_OrderSet”/>

<NavigationPropertyBinding Path=“Supplier”

Target=“SupplierSet”/>

</EntitySet>
<EntitySet Name=“Product_OrderSet”

EntityType=“com_sap_odatademo.Product_Order”>

<NavigationPropertyBinding Path=“Product”

Target=“ProductSet”/>

</EntitySet>
<EntitySet Name=“SupplierSet”

EntityType=“com_sap_odatademo.Supplier”>

<NavigationPropertyBinding Path=“Product”

Target=“ProductSet”/>

</EntitySet>
<Functionimport Name=“ProductsBySupplier”

Function=“com_sap_odatademo.ProductsBySupplier”
EntitySet=“ProductSet”/>

</EntityContainer>
</Schema>

</edmx:DataServices>
</edmx:Edmx>

In some examples, in providing the EDM, a property name of an entity can be identified as a property reference name, which functions as a key for the entity. In some examples, a regular expression can be used to identify a property name as a key. Continuing with the example above, if the property name is [ProductID] and the entity is [Product], then [ProductID], which has the entity name [Product] as a prefix and [ID] as a suffix as determined using a regular expression, is identified as the key of the entity [Product]. In some examples, by default, a property name with the suffix [ID] can be identified as the entity key and foreign entity key. This can be customized for different customer requirements and/or other languages.

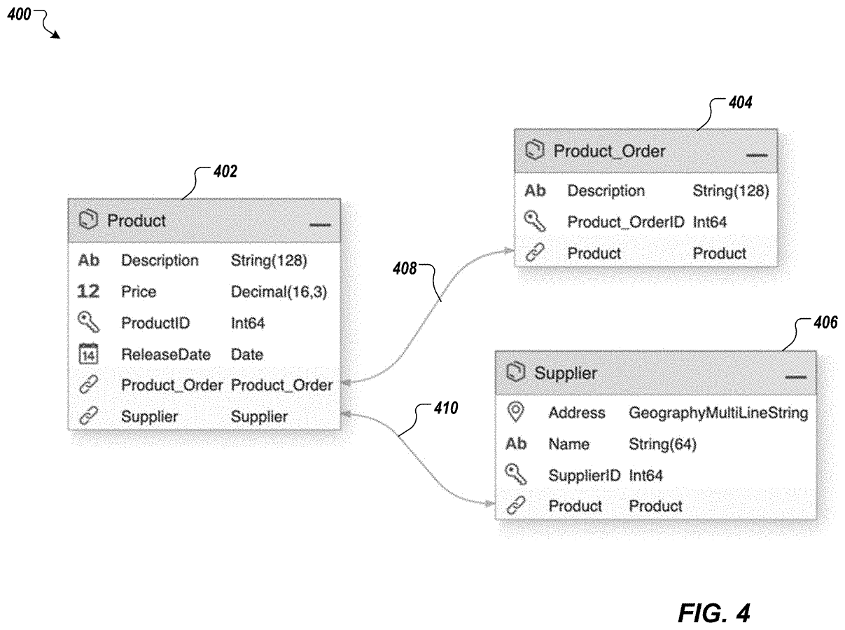

FIG. 4 depicts an example diagram 400 of an OData service generated from the example sketch 300 of FIG. 3A. The example diagram 400 is a visual depiction of the example EDM of Listing 1 above. More particularly, the example diagram 400 includes entities 402, 404, 406 representing the entities determined from the image 300 and includes associations 408, 410 representing associations determined from the image 300.

In accordance with implementations of the present disclosure, the OData EDM is stored in the EDM store 224 and is pipelined to the OData code generator 226, which generates an OData service (e.g., the OData service 228) as computer-executable code. In some examples, the OData code generator 226 is provided as a Java project generator that generates the OData service as a Java project based on an underlying OData EDM. In some examples, the code project generator 250 parses an EDM received from the EDM store 224 and initializes a Java project. In some examples, the code project generator 250 parses the EDM to provide Java code and populates demo data into the Java project.

In general, the OData code generator 226 is provided as one or more existing services (e.g., a comprehensive set of OData service APIs hosted on the cloud, such as the SAP Server OData API provided by SAP SE of Walldorf, Germany). The EDM (in CSDL) is parsed to retrieve the entity definitions and, for each entity, new Java classes (including proxy, listener, and handler classes) are generated, which extends the corresponding classes of the OData service APIs on cloud. For example, the [Product′ entity will have the following Java classes generated (code snippet and details are omitted):

Listing 2: Example Java Classes for [Product] Entity

```
package com.sap.odatademo.proxy;
public class Product
  extends com.sap.cloud.server.odata.EntiyValue
{
  public static final com.sap.cloud.server.odata.Property
description =
com.sap.odatademo.proxy.OdatademoServiceMetadata.EntityTypes.prod
uct.getProperty(“Description”);
  public static final com.sap.cloud.server.odata.Property price
=
com.sap.odatademo.proxy.OdatademoServiceMetadata.EntityTypes.prod
uct.getProperty(“Price”);
  public static final com.sap.cloud.server.odata.Property
productID =
com.sap.odatademo.proxy.OdatademoServiceMetadata.EntityTypes.prod
uct.getProperty(“ProductID”);
  public static final com.sap.cloud.server.odata.Property
releaseDate =
com.sap.odatademo.proxy.OdatademoServiceMetadata.EntityTypes.prod
uct.getProperty(“ReleaseDate”);
  public static final com.sap.cloud.server.odata.Property
supplierID =
com.sap.odatademo.proxy.OdatademoServiceMetadata.EntityTypes.prod
uct.getProperty(“SupplierID”);
...
  public String getDescription( )
  {
```

return

```
com.sap.cloud.server.odata.StringValue.unwrap(this.getDataValue(c
om.sap.odatademo.proxy.Product.description));
    }
...
package com.sap.odatademo.listener;
import com.sap.cloud.server.odata.*;
public class ProductListener extends
com.sap.cloud.server.odata.DefaultEntityListener {
  private com.sap.odatademo.MainServlet servlet;
  private com.sap.odatademo.proxy.OdatademoService service;
  public ProductListener(com.sap.odatademo.MainServlet servlet,
com.sap.odatademo.proxy.OdatademoService service) {
```

super( );
this.servlet = servlet;
this.service = service;
allowUnused(this.servlet);
allowUnused(this.service);

}
super( );

this.servlet = servlet;
this.service = service;
allowUnused(this.servlet);
allowUnused(this.service);

```
  }
....
ppackage com.sap.odatademo.handler;
import com.sap.cloud.server.odata.*;
public class ProductHandler extends
com.sap.cloud.server.odata.DefaultEntityHandler {
  private com.sap.odatademo.MainServlet servlet;
  private com.sap.odatademo.proxy.OdatademoService service;
  public ProductHandler(com.sap.odatademo.MainServlet servlet,
com.sap.odatademo.proxy.OdatademoService service) {
```

super(servlet, service);
this.servlet = servlet;
this.service = service;
allowUnused(this.servlet);
allowUnused(this.service);

}
ublic class ProductHandler extends
com.sap.cloud.server.odata.DefaultEntityHandler {
...

In some examples, the build service receives the code project (e.g., Java project), which builds the code project into a code distribution file. An example code distribution filed includes, without limitation, a Web Application Resource, or Web application Archive (WAR) file, which can be used to distribute a collection of Java archive (JAR) files. Java WAR files can be described as a standard deployable container file format for packaging Java enterprise applications. The generated Java project will be compiled and packaged into a WAR file by the Java compiler and the Jar tool in JDK. In some implementations, Apache Maven, a software project management tool, is used to manage and build the Java project. When the Java project is generated, a project object model (POM) file will be generated, for example:

Listing 3: Example POM

<project>
<groupId>com.sap.odatademo</groupId>

<artifactId>odatademo</artifactId>
<packaging>war</packaging>
<version>1.0.0</version>
<name>OData Demo</name>
...

</project>

When building and packaging the Java project, the Maven WAR Plugin is triggered and used to collect all artifact dependencies, classes and resources of the Java project, before packaging them into WAR archive according to the specifications in the POM file.

In some implementations, the code distribution file is deployed to the OData service generation platform 204 as the OData service 228. In some examples, the OData service 228 is provided as a micro-service. As depicted in FIG. 2, the OData service 228 includes demo data 262. In some examples, demo data can be generated using the OData entities and associations. For each property in an entity, a random value can be generated according to data type. Below is an example record (demo data) of a [Supplier] entity:

Listing 4: Example Record

{

“SupplierID ”: 2022,
“Name”: “Name 1”,
“Address”: {

“Street”: “Street 1”,
“City”: “City 1”,
“State”: “State 1”,
“ZipCode”: “12567”,
“Country”: “Country 1”

},
“ ProductID ”: [6671, 6672]

}

In the example of Listing 4, the random value of “Name” of a product is “Name 1”. For this association (e.g., [ProductID]), an array is created and the value of this array is associated with the property [ProductID] in the entity [Product]. In this example, the array is [6671, 6672], which indicates that two products are supplied by this supplier. Below are two example records for the entity [Product]:

Listing 5: Example Records

```
{
  “ProductID”: 6671,
  “Description”: “Description 1”,
  “ReleaseDate”: “/Date(967792404000)/”,
  “Price”: 9.85,
  “ProductOrderID ”: [3301, 3302]
  “SupplierID”: [2021, 2023]
}
{
  “ProductID ”: 6672,
  “Description”: “Description 2”,
  “ReleaseDate”: “/Date(1264144404000)/”,
  “Price”: 416.31,
“ProductOrderID”: [3303]
  “SupplierID”: [2021]
}
```

In some implementations, in response to the OData service 228 being available, a notification (e.g., a push notification) is sent from the OData service generation platform 204 to the OData demo client 210 executing on the remote device 202. In some examples, each OData generator client 208 is managed by an application management service of the cloud platform. When the OData generator client 208 signs in and onboards a cloud platform, a unique connection session is established between the OData generator client 208 and the cloud platform. Therefore, when the OData service 228 is generated, a unique identifier corresponding to the OData generator client 208 is assigned to the OData service 228. The notification is be pushed to the corresponding OData generator client 208 using the unique identifier when the OData service 228 is ready. In response to receiving the notification, the OData demo client 210 can retrieve metadata from the OData service 228 and generate master-detail pages for each entity and its associated entities to showcase the OData service 228.

In some implementations, metadata describing entities, data types, properties, and relationships can be queried from the OData service 228. Example metadata for the entity [Supplier] can be provided as:

Listing 6: Example Metadata

<EntityType Name=“Supplier”>

<Key>
<PropertyRef Name=“SupplierID”/>
</Key>
<Property Name=“Address”

Type=“Edm.GeographyMultiLineString” Nullable=“false” SRID=“0”/>

<Property Name=“Name” Type=“Edm.String”

Nullable=“false” MaxLength=“64”/>

<Property Name=“SupplierID” Type=“Edm.Int64”

Nullable=“false”/>

<NavigationProperty Name=“Product”

Type=“com_sap_odatademo.Product” Nullable=“false”
Partner=“Supplier”/>
</EntityType>

In some examples, the metadata is converted to mobile application metadata to depict how the master details page of [Supplier] is to be rendered on the OData demo client 210 on the remote device 202. For example, and continuing with the example above, the key property of the entity [Supplier] (i.e., [SupplierID]) is populated to a list of UI controls of ObjectCells on the master page, and the data to be rendered on the ObjectCell is bound to the entity [Supplier] by setting the [EntitySet] and [Service] in the property group [Target]. Therefore, the number of ObjectCells will be the number of records the entity [Supplier] has and each ObjectCell will be populated with data from each record of [Supplier] entity accordingly.

A PageToOpen′ event handler is added the ObjectCell, when end user presses any ObjectCell, it will navigate to the ‘Supplier_Detail’ page with the data record of the pressed ObjectCell as a parameter. Further, in the Supplier detail page, a list of KeyAndValues controls will display all the properties values of the current Supplier data record, SupplierID′, ‘Name’, ‘Address’ etc. The Supplier detail page will render a list of ObjectCells for each property associated with another Entity, as a foreign key property. In this example, [ProductID] is foreign key of the associated entity [Product]. The Supplier detail page will list the Product IDs of the current supplier.

As discussed above, implementations of the present disclosure leverage ML models for automatic generation of OData services. In some examples, the ML models are existing ML models (e.g., ML models provided by third-party providers). That is, implementations of the present disclosure can be realized without generating ML models from scratch. In some examples, one or more ML models are provided as CNNs of artificial intelligence (AI) service provider (e.g., Functional Services API of SAP Leonardo Machine Learning Foundation provided by SAP SE of Walldorf, Germany).

In some examples, an ML model is trained based on training data to provide functionality described herein. In general, the ML model is iteratively trained, where, during an iteration, one or more parameters of the ML model are adjusted, and an output is generated based on the training data. For each iteration, a loss value is determined based on a loss function. The loss value represents a degree of accuracy of the output of the ML model. The loss value can be described as a representation of a degree of difference between the output of the ML model and an expected output of the ML model (the expected output being provided from training data). In some examples, if the loss value does not meet an expected value (e.g., is not equal to zero), parameters of the ML model are adjusted in another iteration of training. In some instances, this process is repeated until the loss value meets the expected value.

In some examples, and with regard to image classification, an existing image classification ML model (e.g., provided as part of AI services) can be retrained using training data that includes images of hand-drawn sketches of data models (e.g., hundreds or thousands of images), each image being labeled as hand-drawn (e.g., supervised training). This training data can be used on its own or can be included as part of an existing training data set. After retraining, the image classification ML model will be able to accurately determine whether the image depicts a hand-drawn sketch.

In some examples, and with regard to layout analysis, an existing layout analysis ML model (e.g., provided as part of AI services) can be retrained using training data having layout labels provided therein (e.g., supervised training). To achieve an improved training result, the training data set of hand-drawn data model sketch can be labelled by adding layout labels. For example, rectangles can be digitally added to images as layout labels and the so-labeled images can be included in a training data set. In some examples, the layout labels can be recorded in the training data set in JSON or Excel format. In some examples, a rectangle (layout label) can be digitally recorded as:

```
{
  “LabelId”: “ a3ae31d1-4995-4303-8076-2bdf6a91e6e0 ”,
  “left”: 26px,
  “top”: 906px,
  “width”: 1035px,
```

“height”: 1895px

}

After training using the training data set (e.g., hundreds to thousands of images of hand-drawn data model sketches labelled with layout labels), the object detection ML model will be able to detect different objects, like entity, associations in sections of hand-drawn data model sketches. In some example, the identified objects are sent to the text recognition ML model for further processing, as described herein.

In some examples, and with regard to text recognition, an existing text recognition ML model can be retrained with a training data set of handwritten text of OData entity properties and associations. A customized training data set of handwriting of different persons can be used to provide improved recognition rates and accuracies. After training of the ML model (e.g., using hundreds to thousands of images of hand-drawn data model sketch labelled with layout labels), the layout analysis ML model will be able to accurately analyze the layout in new hand-drawn data model sketches into different sections, where each section contains an OData entity. These sections will be sent to Object detection CNN for further processing. For example, from above image, a list of three sections will be generated.

In some examples, an existing image classification ML can be retrained with a training data set, which includes of hundreds of different sections depicted in images, which have been labelled by adding labels of entity and association to each object within the images. For example, the sections generated in previous step, are labelled by adding the rectangles with text labels of objects as entities or association. In some examples, the object labels can also be recorded in the training data set in JSON or Excel format.

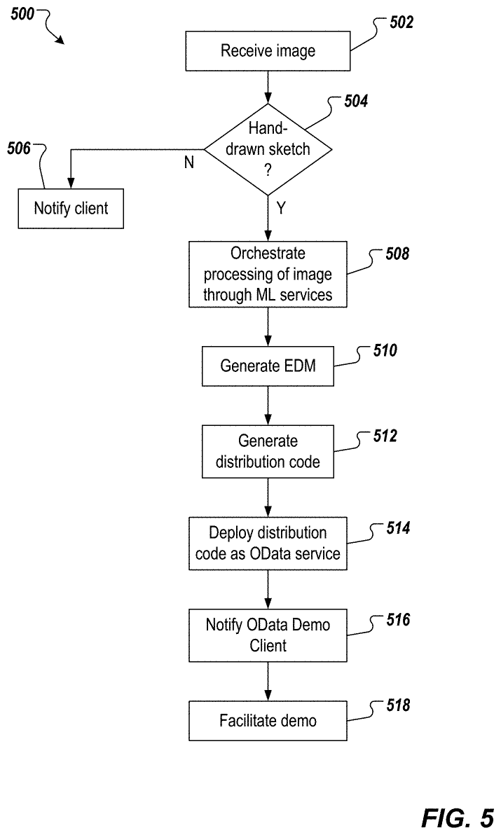

FIG. 5 depicts an example process 500 that can be executed in accordance with implementations of the present disclosure. In some examples, the example process 500 is provided using one or more computer-executable programs executed by one or more computing devices.

An image is received (502). For example, and as described herein, the image 300 is received by the OData service generation platform 204 from the remote device 202. In some examples, the image 300 is captured by the remote device 202 and is pre-processed (e.g., to adjust one or more parameters). The image 300 is transmitted from the remote device 202 to the OData service generation platform 204. It is determined whether the image depicts a hand-drawn sketch (504). For example, and as described herein, the image 300 is processed by the image classification service 240, which processes the image 300 through a ML model (e.g., a CNN) to selectively classify the image 300 as depicting a hand-drawn sketch. If the image does not depict a hand-drawn sketch, a client is notified (506) and processing of the image ends. For example, a message is sent to the remote device 202 indicating that the image will not be processed to automatically generate an OData service.

If the image depicts a hand-drawn sketch, further processing of the image is orchestrated with ML services (508). For example, and as described herein, the ML orchestrator 234 provides the image 300 for processing by each of the layout analysis service 242, the object detection service 244, and the text recognition service 246, and receives respective output from each, as described herein. An EDM is generated (510). For example, and as described herein, the OData EDM generator 220 iteratively populates a template EDM using the output provided from the ML services to provide the OData EDM.

Distribution code is generated (512). For example, and as described herein, the EDM is stored in the EDM store 224 and is pipelined to the OData code generator 226, which generates an OData service (e.g., the OData service 228) as distribution code (e.g., computer-executable code). The distribution code is deployed as an OData service (514). For example, and as described herein, the distribution code is executed within the OData service generation platform 204 to provide the OData service 228. The OData demo client is notified (516). For example, and as described herein, in response to the OData service 228 being available, a notification (e.g., a push notification) is sent from the OData service generation platform 204 to the OData demo client 210 executing on the remote device 202. Demo of the OData service is facilitated (518). In response to receiving the notification, the OData demo client 210 can retrieve metadata from the OData service 228 and generate master-detail pages for each entity and its associated entities to showcase the OData service 228.

Implementations of the present disclosure provide a service provisioning platform that automatically generates OData services from images using ML. As described herein, implementations of the present disclosure provide a no-code development solution, which enables services to be generated absent coding by a developer. In this manner, the service provisioning platform enables generation of services by non-technical users (e.g., sales teams, business analysts), who may have little to no coding and/or development experience and/or knowledge. Implementations of the present disclosure provide one or more technical advantages. An example advantage, the service provisioning platform significantly decreases the time and technical resources traditionally expended to provide services. For example, the service provisioning platform enables services to be provisioned in minutes, as opposed to traditional approaches that can take days or weeks. As another example, expenditure of technical requirements is reduced, because computing resources that a developer would otherwise use to generate, debug, and test a service are foregone. That is, the no-code approach of the present disclosure obviates the need for computing resources a developer would use to generate code for a service.

Another example advantage is that services can be generated in real-time or near real-time due to the efficiency of ML models and/or the scalability of cloud platforms, on which the service provisioning platform is executed. Further, the service provisioning platform can response to any changes in images (e.g., changes in sketches), enabling regeneration of a service on-the-fly to account for such changes.

Implementations of the present disclosure also support multi-cloud deployment and can be implemented with standard ML services from different cloud service providers. This greatly reduces the effort to build original ML services that would otherwise be required. Further, the ML models can be retrained with customer-specific data sets to provide a higher accuracy in generations of services (i.e., services that are more accurate to the sketches than using ML models trained on data sets that are not or only partially customer-specific.

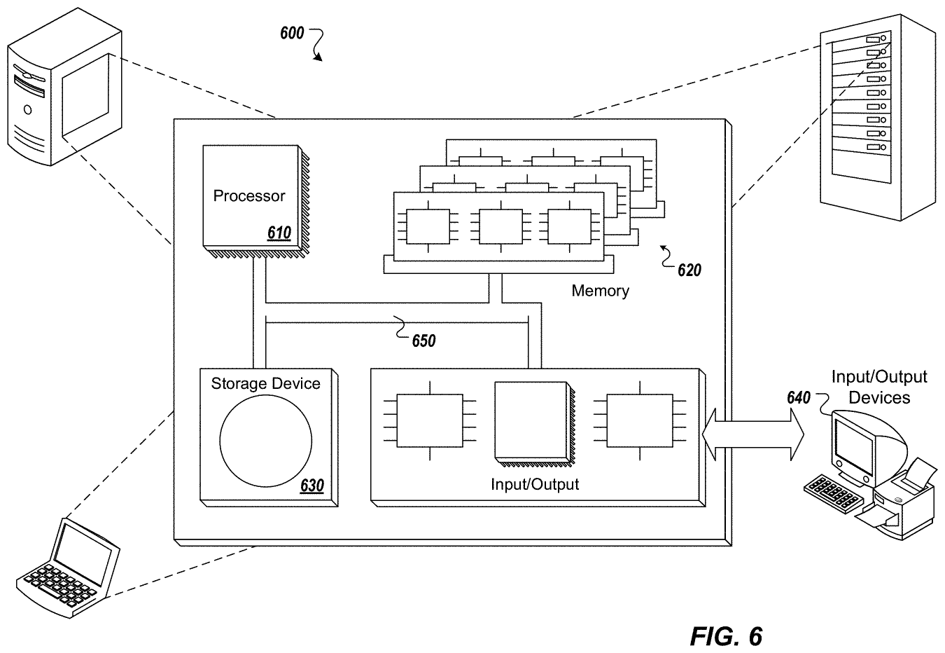

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for automated provisioning of Open Data Protocol (OData) services using machine learning (ML) models, the method being executed by one or more processors and comprising:
receiving, by an OData service generation platform executed in one or more cloud-computing environments, an image comprising data representative of a sketch on a physical artifact, the image being provided as a computer-readable image file;
processing, by the OData service generation platform, the image using a set of ML models to detect depiction of two or more entities and at least one association between entities, the set of ML models comprising at least one layout analysis ML model to identify two or more sections within images, at least one object detection ML model to identify one or more of entities and associations in each section of the two or more sections, and at least one text recognition ML model to determine text associated with entities in sections;
generating, by the OData service generation platform, an entity data model (EDM) based on output of the set of ML models, the output comprising the two or more entities and the at least one association; and
providing, by the OData service generation platform, an OData service based on the EDM.

2. The method of claim 1, wherein processing, by the OData service generation platform, the image is performed in response to determining that the image depicts the sketch using at least one ML model.

3. The method of claim 1, wherein generating the EDM at least partially comprises populating a template EDM based on the output.

4. The method of claim 1, wherein the EDM is provided in Common Schema Definition Language (CSDL).

5. The method of claim 1, wherein the image is pre-processed to adjust one or more parameters prior to execution of processing, by the OData service generation platform, the image.

6. The method of claim 5, wherein the image is pre-processed by a remote device before being transmitted to the OData service generation platform.

7. The method of claim 1, wherein one or more ML models comprise a convolutional neural network (CNN).

8. A non-transitory computer-readable storage medium coupled to one or more processors and having instructions stored thereon which, when executed by the one or more processors, cause the one or more processors to perform operations for automated provisioning of Open Data Protocol (OData) services using machine learning (ML) models, the operations comprising:
receiving, by an OData service generation platform executed in one or more cloud-computing environments, an image comprising data representative of a sketch on a physical artifact, the image being provided as a computer-readable image file;
processing, by the OData service generation platform, the image using a set of ML models to detect depiction of two or more entities and at least one association between entities, the set of ML models comprising at least one layout analysis ML model to identify two or more sections within images, at least one object detection ML model to identify one or more of entities and associations in each section of the two or more sections, and at least one text recognition ML model to determine text associated with entities in sections;
generating, by the OData service generation platform, an entity data model (EDM) based on output of the set of ML models, the output comprising the two or more entities and the at least one association; and
providing, by the OData service generation platform, an OData service based on the EDM.

9. The computer-readable storage medium of claim 8, wherein processing, by the OData service generation platform, the image is performed in response to determining that the image depicts the sketch using at least one ML model.

10. The computer-readable storage medium of claim 8, wherein generating the EDM at least partially comprises populating a template EDM based on the output.

11. The computer-readable storage medium of claim 8, wherein the EDM is provided in Common Schema Definition Language (CSDL).

12. The computer-readable storage medium of claim 8, wherein the image is pre-processed to adjust one or more parameters prior to execution of processing, by the OData service generation platform, the image.

13. The computer-readable storage medium of claim 12, wherein the image is pre-processed by a remote device before being transmitted to the OData service generation platform.

14. The computer-readable storage medium of claim 8, wherein one or more ML models comprise a convolutional neural network (CNN).

15. A system, comprising:
a computing device; and
a computer-readable storage device coupled to the computing device and having instructions stored thereon which, when executed by the computing device, cause the computing device to perform operations for automated provisioning of Open Data Protocol (OData) services using machine learning (ML) models, the operations comprising:
receiving, by an OData service generation platform executed in one or more cloud-computing environments, an image comprising data representative of a sketch on a physical artifact, the image being provided as a computer-readable image file;
processing, by the OData service generation platform, the image using a set of ML models to detect depiction of two or more entities and at least one association between entities, the set of ML models comprising at least one layout analysis ML model to identify two or more sections within images, at least one object detection ML model to identify one or more of entities and associations in each section of the two or more sections, and at least one text recognition ML model to determine text associated with entities in sections;
generating, by the OData service generation platform, an entity data model (EDM) based on output of the set of ML models, the output comprising the two or more entities and the at least one association; and
providing, by the OData service generation platform, an OData service based on the EDM.

16. The system of claim 15, wherein processing, by the OData service generation platform, the image is performed in response to determining that the image depicts the sketch using at least one ML model.

17. The system of claim 15, wherein generating the EDM at least partially comprises populating a template EDM based on the output.

18. The system of claim 15, wherein the EDM is provided in Common Schema Definition Language (CSDL).

19. The system of claim 15, wherein the image is pre-processed to adjust one or more parameters prior to execution of processing, by the OData service generation platform, the image.

20. The system of claim 19, wherein the image is pre-processed by a remote device before being transmitted to the OData service generation platform.
